(19) United States
(12) Patent Application Publication
(10) Pub. No.: US 2006/0106628 A1
(43) Pub. Date: May 18, 2006

(54) Centralized system and method for notifying occupant of completion of home showing

(75) Inventors: Robert J. Faherty, Overland Park, KS (US); Kevin M. Faherty, Denver, CO (US); William C. Faherty, El Segundo, CA (US)

Correspondence Address: Michael J. Bolan, 14 Trinity, Irvine, CA, 92612, US

(73) Assignee: Centralized Showing Service, Inc.

(21) Appl. No.: 10/990,875

(22) Filed: Nov. 17, 2004

(51) Int. Cl. G06Q 99/00

(52) U.S. Cl. 705/1

(57) ABSTRACT

Methods and systems for facilitating sale of a home in which an occupant is absent are provided. A resident communications system is installed at the home. Upon completion of a showing at the home by a real estate agent, a signal is transmitted from the resident communication system. The signal can be a home identifier that is subsequently received by a centralized showing system, which correlates the home identifier with a logical address of a handheld communications device carried by the occupant, and contacts and informs the occupant via the handheld communications device that the home showing has been completed. Or the signal can be a notification signal that is transmitted directly to the handheld communications device for notifying the occupant that the home showing has been completed. The resident communications system may have a base unit and a remote unit, such as a lockbox, that can be placed near the ingress/egress of the home and actuated to transmit an activation signal to the base unit, which then transmits the signal to centralized showing system or directly to the handheld communications device.

### FIELD OF THE INVENTION

The present invention relates to systems and methods directed to improving real estate transactions, and more particularly, to systems and methods for improving the home showing aspect of the real estate transaction process.

### BACKGROUND

Real estate transactions typically involve the use of real estate agents that set up and coordinate real estate showings and sales. A potential property seller typically uses a listing agent to organize and facilitate the sale of the property, while a potential property buyer uses a showing agent to set up showings and to facilitate the purchase of a property.

When a real estate agent shows a property to a potential buyer, the occupant of the property, which may or may not be the property seller, is typically requested to vacate the premises to allow the potential buyer to view the property in private. A typical duration for the occupant of the property to be absent is two to three hours. Typically, the showing agent does not have a readily accessible means for contacting the absent occupant (e.g., the showing agent will not have a cell phone number of the occupant), and, as the potential buyer's agent, would be somewhat inappropriate to personally contact the occupant. As such, the occupant will remain absent from the property for the full duration even if the showing is completed within the first fifteen minutes of the requested duration.

For this reason, it would be desirable to provide improved systems and methods for improving the efficiency of the home showing aspect of a real estate transaction process.

### SUMMARY OF THE INVENTION

In accordance with a first aspect of the present inventions, a method for facilitating the sale of a home from which an occupant is absent is provided. The home has a resident communications system that stores a home identifier correlatable to a handheld communications device. That is, the home identifier allows the handheld communications device to be subsequently contacted. The home identifier can take the form of any identifier that allows one home to be distinguished over another. For example, the home identifier may be at least one of a residential address of the home, a property identification number (PIN), a multiple service listing (MSL) number, a serial number, or a phone number.

The method comprises showing the home to a potential home buyer, and transmitting the stored home identifier from the resident communications system upon completion of the home showing. The home identifier can be transmitted over any communications medium, such as a public switched telephone network (PSTN), wireless telephone network, an internet protocol (IP) network, or directly over-the-air. The home identifier can be transmitted to any entity, but in the preferred method, is transmitted to a centralized showing system, which can then notify the occupant via the handheld device. Optionally, subjective and/or objective showing feedback information can be acquired at the resident communications system.

In one method, the resident communications system comprises a base unit and a remote unit, in which case, the method further comprises transmitting an activation signal from the remote unit to the base unit, and in response thereto, transmitting the home identifier from the base unit. The activation signal may be wirelessly transmitted from the remote unit to the base unit, so that, e.g., the remote unit can be easily and conveniently located at the ingress/egress of the home. The remote unit may, e.g., comprise a lockbox, in which case, the home identifier may be transmitted in response to operation of the lockbox, e.g., when locking a key within the lockbox. In any event, the home identifier is preferably transmitted in response to the mechanical actuation of a single switch, which may be located in the lockbox or may be a simple as a button that can be depressed. In this manner, minimal additional work is required on the part of the showing agent in actuating transmission of the home identifier from the resident communications system. Optionally, an egress event may be automatically sensed, e.g., by sensing an radio frequency identification (RFID) tag associated with the home key, in which case, the home identifier may be transmitted in response to the sensed egress event. In this case, no manual activation is required to initiate transmission of the home identifier.

In accordance with a second aspect of the present inventions, another method for facilitating the sale of a home from which an occupant is absent is provided. The method is similar to the previously described method, with the exception that a lockbox can be operated to transmit the home identifier upon completion of the home showing. The lockbox can be a remote unit that transmits an activation signal to a base unit, which then transmits the home identifier, or can directly transmit the home identifier itself. In this manner, the showing agent need not perform any activity other than those normally performed by the agent when showing a home to a potential buyer.

In accordance with a third aspect of the present inventions, another method for facilitating the sale of a home from which an occupant is absent is provided. The home has a resident communications system that stores a logical address of the handheld communications device. The logical address can take the form of any address that allows one handheld communications device to be distinguished over another. For example, the logical address can be a telephone number, an e-mail address, or a specific frequency.

The method comprises showing the home to a potential home buyer, and transmitting a notification signal to the handheld communications device in accordance with the stored logical address upon completion of the home showing. The notification signal can be transmitted over any communications medium, such as a public switched telephone network (PSTN), wireless telephone network, an IP network, or directly over-the-air. The notification signal may comprise any signal that is capable of indicating to the occupant that the home showing has been completed. For example, the notification signal may be a pre-recorded voice message or an activation signal configured to prompt the handheld communications device playback a pre-recorded voice message stored therein. Or, the notification signal may comprise a text message or an electronic mail message. The resident communications system may comprise a base unit and a remote unit that can be configured and operated in the same manner described above to actuate transmission of the notification signal. Optionally, subjective and/or objective showing feedback information can be acquired at the resident communications system.

In accordance with a fourth aspect of the present inventions, still another method for facilitating the sale of a home from which an occupant is absent is provided. The method is similar to the previously described method, with the exception that a lockbox can be operated to transmit the notification signal upon completion of the home showing. The lockbox can be a remote unit that transmits an activation signal to a base unit, which then transmits the notification signal, or can directly transmit the notification signal itself. In this manner, the showing agent need not perform any activity other than those normally performed by the agent when showing a home to a potential buyer.

In accordance with a fifth aspect of the present inventions, a centralized method of facilitating the sales of homes from which occupants are absent is provided. The method comprises receiving the previously described home identifiers. The home identifiers can be received over any communications medium, such as a public switched telephone network (PSTN), wireless telephone network, an IP network, or directly over-the-air. The method optionally comprises receiving and storing subjective and/or objective showing feedback information.

The method further comprises correlating the home identifiers with the handheld communications devices, e.g., by matching the home identifiers with logical addresses of the handheld communications devices. The method further comprises contacting the occupants via the respective handheld communications device in accordance with the correlated home identifiers. The occupants can be immediately contacted upon the receipt of the respective home identifiers, or contacted after a predetermined period of time has expired after receipt of the respective home identifiers. The occupants can be manually contacted (i.e., a human operator initiates contact) or automatically contacted. In the preferred method, the occupants are wirelessly contacted, so that they can freely roam about with the handheld communications devices.

Once the occupants are contacted, the method comprises informing the occupants that the showings of the respective homes have been completed. For example, the occupants can be informed via voice (either a live voice or a pre-recorded voice message). If informed via a pre-recorded voice message, the voice messages can either be transmitted to the respective handheld communications devices, or activation signals can be transmitted to prompt the respective handheld communications devices to playback the voice messages. Alternatively, the occupants can be informed via text messages or electronic mail messages.

In accordance with a sixth aspect of the present inventions, a centralized showing system for facilitating the sale of homes from which occupants are absent is provided. The system comprises means for receiving the previously described home identifiers. For example, the receiving means may be a telephonic device, such as an interactive voice recognition (IVR) device, an IP server, or a radio frequency (RF) receiver. The receiving means may optionally be configured for receiving showing feedback information, in which case, it can comprise memory for storing such showing feedback information.

The system further comprises a processor configured for correlating the received home identifiers with the handheld communications devices. The system may further comprise a look-up table for storing the home identifiers and corresponding logical addresses for the handheld communications devices, in which case, the processor is configured for accessing the look-up table to perform the correlation function.

The system further comprises means for automatically contacting the occupants via the respective handheld communications device in accordance with the correlated home identifiers, and informing the occupants that the showings of the respective homes have been completed. For example, the contact means can comprise a telephonic device, such as an autodialer, an IP server, or a radio frequency (RF) transmitter. The contacting means may optionally be configured to delay contact with at least one of the occupants after receipt of a respective home identifier.

In accordance with a seventh aspect of the present inventions, another system for facilitating the sale of homes from which occupants are absent is provided. The system comprises a plurality of resident communications systems located at the respective homes, the resident communications systems configured for transmitting the previously described home identifiers from the respective homes. Each resident communication system may include a base unit and a remote unit that can be configured and operated in the same manner previously described.

The system further comprises a centralized showing system configured for receiving the transmitted home identifiers, correlating the received home identifiers with the handheld communications devices, contacting the occupants via the respective handheld communications devices in accordance with the correlated home identifiers, and informing the occupants that the showings of the respective homes have been completed. In one preferred embodiment, the centralized showing system is configured for automatically contacting and informing the occupants to provide a more efficient and convenient means for notifying the occupants that the showings of the homes have been completed. Optionally, each resident communications system can be configured for transmitting showing feedback information, in which case, the centralized showing system can be configured for receiving the transmitted showing feedback information from the resident communications systems, and storing the received showing feedback information.

In accordance with an eighth aspect of the present inventions, a resident communications system for facilitating the sale of a home from which an occupant is absent is provided. The system comprises a remote unit configured for being actuated to transmit an activation signal, and a base unit configured for receiving the activation signal, and in response thereto, transmitting a message to a handheld communication device carried by the occupant. The message expressly indicates that a showing of the home has been completed. For example, the message can be a pre-recorded voice message, a text message, or an e-mail message. The remote unit and base unit can be configured in the same manner as that previously described.

In accordance with a ninth aspect of the present inventions, a system for facilitating the sale of a home from which an occupant is absent is provided. The system comprises a handheld communications device having a logical address and being configured for providing the occupant with a message expressly indicating that a showing of the home has been completed in response to a notification signal. For example, the message can be a pre-recorded voice message contained within the notification signal, or a pre-recorded voice message stored in the handheld communications device that is played back in response to the notification signal. Or, the message can be a text message or an electronic mail message.

The system further comprises a resident communications system located at the home. The resident communications system stores the logical address of the handheld communications system and is configured for transmitting a notification signal to the handheld communications device in accordance with the stored logical address upon completion of the home showing. The resident communication system may comprise a remote unit and a base unit configured as previously described.

Although the present inventions lend themselves well to real estate transactions involving home showings, which require the occupants of the homes to repeatedly leave the homes, sometimes several times a day, they can also be applied to other situations where it is desirable for occupants to leave their homes in order to complete tasks at their homes. For example, when performing a task at a home that renders the home temporarily unlivable, such as, e.g., electrical, plumbing, or pest control work, it may be desirable for the occupant to leave the home. In this case, when the worker has completed the task, the absent occupant can be contacted and notified by the worker in the same manner as previously described with respect to the showing agent.

Other and further aspects and features of the invention will be evident from reading the following detailed description of the preferred embodiments, which are intended to illustrate, not limit, the invention.

### BRIEF DESCRIPTION OF DRAWINGS

The drawings illustrate the design and utility of preferred embodiment(s) of the invention, in which similar elements are referred to by common reference numerals. In order to better appreciate the advantages and objects of the invention, reference should be made to the accompanying drawings that illustrate the preferred embodiment(s). The drawings, however, depict the embodiment(s) of the invention, and should not be taken as limiting its scope. With this caveat, the embodiment(s) of the invention will be described and explained with additional specificity and detail through the use of the accompanying drawings in which:

FIG. 1 is a block diagram of one embodiment of a home showing notification system arranged in accordance with the present inventions;

FIG. 2 is a block diagram of a resident communications system used in the system of FIG. 1;

FIG. 3 is a block diagram of a lock box that can be used as a remote unit in the resident communications system of FIG. 2;

FIG. 4 is a block diagram of a centralizing showing system used in the system of FIG. 1;

FIG. 5 is a flow diagram illustrating the operation of the system of FIG. 1;

FIG. 6 is a block diagram of another embodiment of a home showing notification system arranged in accordance with the present inventions; and

FIG. 7 is a flow diagram illustrating the operation of the system of FIG. 6.

### DETAILED DESCRIPTION OF THE ILLUSTRATED EMBODIMENTS

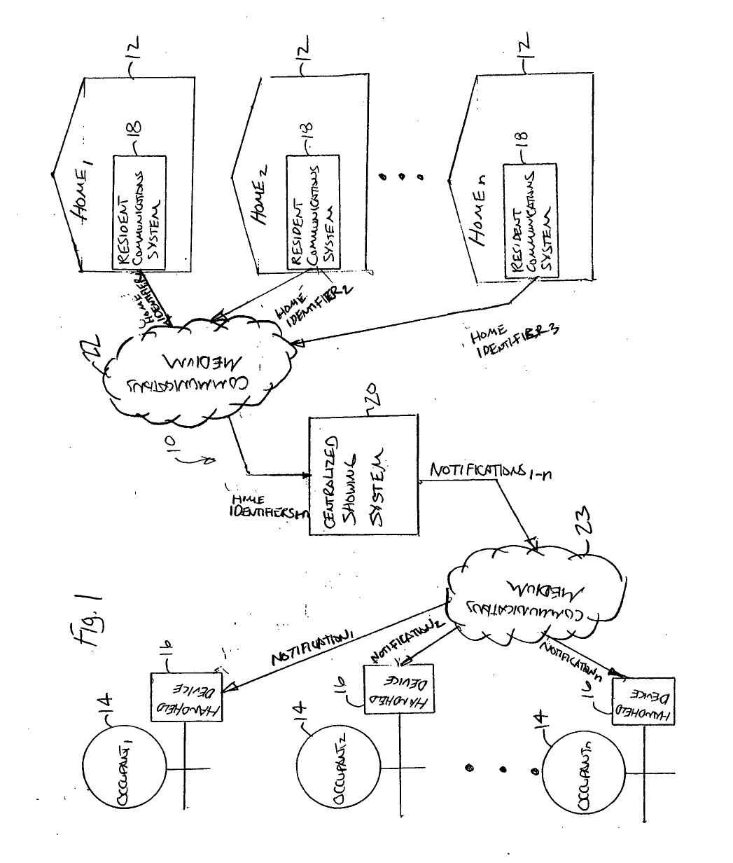

Referring generally to FIG. 1, a home showing notification system 10 arranged in accordance with one embodiment of the present invention will now be described. The system 10 is designed to facilitate the sale of homes 12 from which occupants 14 are absent by notifying the occupants 14 that the showings of the respective homes 12 in which they reside have been completed. In the illustrated embodiment, an n number of homes 12 with a corresponding n number of occupants 14 are shown to convey that any number of homes 12/occupants 14 can be serviced by the system 10. It should be noted that homes 12 can take the form of any domicile in which an occupant 14 can reside, and thus, need not be limited to single family houses, but rather can include apartments, condominiums, trailer homes, house boats, etc.

In performing the notification function, the system 10 generally comprises a plurality of handheld communications devices 16 that are carried by the respective occupants 14, a plurality of resident communications systems 18 that are located at the respective homes 12, and a centralized showing system 20 configured for obtaining showing information from the resident communications systems 18 over a communications medium 22, and in response thereto, transmitting notification information to the handheld communications devices 16 over a communications medium 23. As will be described in further detail below, the communications media 22/23 preferably takes the form a public switched telephone network (PSTN), but can also take the form of any other media, such as a wireless telephone network, an Internet Protocol (IP) network, or air (in the case of direct wireless communications).

Each handheld communications device 16 is preferably compact enough for the respective occupant 14 to conveniently carry around on his or her person, e.g., in a pocket or purse. The nature of the handheld communications device 16 will ultimately depend on the desired means for communicating notification information to the occupant 14, but preferably takes the form of a device that can wirelessly receive information, so that occupant 14 has freedom to roam away from his or her home and still be more easily contacted. For example, the handheld communications device 16 may take the form of a commercially available cellular telephone that can receive voice mail and/or text messages, personal digital assistants (PDAs) that can receive text messages, or devices that can receive electronic mail messages, such as Blackberry® devices. Because many persons already own at least one of these devices, they provide a low-cost and convenient means for contacting the occupants 14.

Alternatively, the handheld communications device 16 may take the form a dedicated device that is specifically designed for the system 10. For example, the dedicated handheld communications device 16 may take the form of a radio receiver that stores a recording that verbally informs the occupant 14 that the home showing has been completed. This recording can be played back to the occupant 14 upon receipt of a wireless signal. In this case, the design of the handheld communications device can be simplified, thereby minimizing the production costs of the handheld communications device 16, and allowing the devices to be freely distributed by the system operator to occupants 14. This communications means is useful in cases where the occupant 14 does not already own a non-dedicated wireless device, such as those described above.

Each handheld communications device 16 has a logical address at which it can be contacted and provided information. For example, if the handheld communications device 16 is a cellular telephone, the logical address will be a telephone number. If the handheld communications device 16 is an electronic mail device, the logical address will be an electronic mail address. If the handheld communications device 16 is a radio receiver, the logical address may be a specific frequency. As will be described in further detail below, if the handheld communications device 16 is dedicated in that it is provided to the occupant 14 by the system operator, the listing agent need not inform the system 10 of its logical address, which presumably will already have been stored in the system 10 prior to its distribution to the occupant 14.

Each resident communications system 18 is configured for transmitting a home identifier from the home 12 at which the resident communications system 18 is located. As illustrated in FIG. 1, an n number of home identifiers are transmitted from the n number of respective resident communications systems 18. The home identifier can be any information that can be used to distinguish the homes 12 from each other. For example, the home identifier may be the residential address of the home 12 (e.g., 1833 μm Street, Los Angeles, Calif.), a property identification number (PIN), which is generally assigned by the country of the property, a multiple service listing (MSL) number used to list the home 12 for sale, a serial number, or a phone number. As will be described in further detail below, this home identifier will be used to notify the occupant 14 of the home 12 that the showing has been completed.

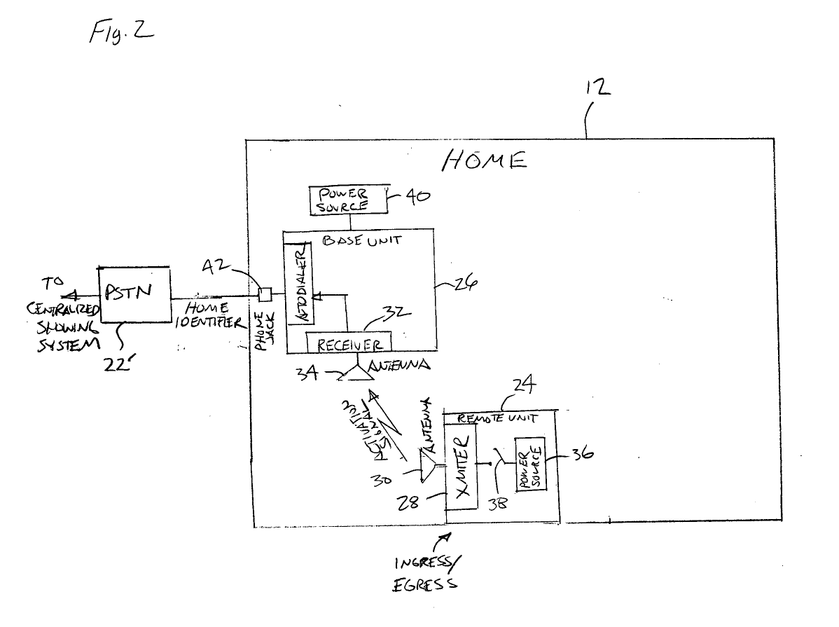

Referring further to FIG. 2, each resident communications system 18 comprises a remote unit 24, which is conveniently located at the ingress/egress of the home 12, and a base unit 26 located near a power source. The remote unit 24 is configured for transmitting an activation signal to the base unit 26, and the base unit 26 is configured for transmitting the respective home identifier in response to the receipt of such activation signal.

In the illustrated embodiment, remote unit 24 comprises a wireless transmitter 28 and associated antenna 30 for wirelessly transmitting the activation signal, and the base unit 26 comprises a wireless receiver 32 and associated antenna 34 for wirelessly receiving the activation signal. In the preferred embodiment, a short range wireless communications protocol, such as Bluetooth or Home RF, is used to transmit the activation signal between the remote unit 24 and base unit 26. In alternative embodiments, the remote unit 24 and base unit 26 may be hardwired together, although such an arrangement may not be as convenient and easily installed and removed as a wireless configuration.

The remote unit 24 comprises an internal power source 36, such as a battery, but can be connected to an external source, such as a 110-120 volt outlet. The power source 36 is connected to the transmitter 28 through a switch 38, which when closed, causes the transmitter 28 to transmit the activation signal via the antenna 30. The base unit 26 will typically use more power than the remote unit 36, and thus, is preferably connected to an external power source 40, such as a 110-120 volt outlet or a low voltage direct current (DC) source, such as a standard telephone jack. Alternatively, however, the base unit 26 may have an internal power source, such as a battery.

The base unit 26 may be configured for transmitting the home identifier to the centralized showing system 20 via any one of a variety of communications means. In the illustrated embodiment, the base unit 26 is connected to the communications medium 22 via a standard telephone jack 42. In this case, the communications medium 22 takes the form of a PSTN 22′. Alternatively, the base unit 26 can be configured for being wirelessly connected to a wireless cellular network (as the communications medium 22), in which case, it will contain an radio frequency (RF) transmitter and antenna (not shown), much like a conventional wireless telephone. In either case, the base unit 26 comprises a conventional autodialer 44 configured for making a phone call to the centralizing showing system 20 upon receipt of the activation signal from the remote unit 24. That is, the autodialer 44 will seize the telephone line and transmit a contact phone number of the centralized showing system 20 to the PSTN 22′ (or wireless cellular network) using, e.g., DTMF tones. The PSTN 22′ will then, in turn, connect the centralized showing system 20 to the autodialer 44. The autodialer 44 will then transmit the home identifier over the phone line to the centralized showing system 20, e.g., using DTMF tones or a prerecorded message. Alternatively, if the centralized showing system 20 has caller identification capability, the autodialer 44 does not transmit a home identifier. Rather, as part of the caller identification function, the PSTN 22 will transmit a home identifier in the form of caller identification signals to the centralized showing system 20 upon connecting with the autodialer 44.

Alternatively, the base unit 26 may be configured for transmitting the home identifier to the centralized showing system 20 in non-telephonic manners. For example, the base unit 26 may include a long-range transmitter and antenna that allows the base unit 26 to transmit the home identifier directly to the centralized showing system 20 over the air (as the communications medium 22). Or, the base unit 26 can take the form of a computer that can be connected to an IP network (as the communications medium 22) via a telephonic line or hi-speed data line. In this case, the base unit 26 will include a modem for communicating the home identifier over the IP network to the centralized showing system 20 using means, such as electronic mail.

The remote unit 24 is configured for conveniently allowing a real estate agent, and in particular, a showing agent, to transmit the activation signal from the remote unit 24, and thus, the home identifier from the base unit 26, upon the completion of the showing. That is, the showing agent is required to perform only a minimal amount of tasks, or no tasks, in addition to those that are typically performed by the agent in showing the home 12.

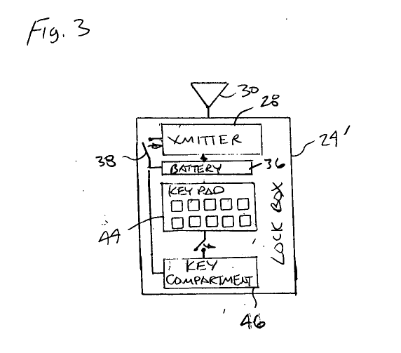

For example, as illustrated in FIG. 3, the remote unit 24 takes the form of a lockbox, which like conventional lockboxes, can be located on or near the entry doorway to the home 12. In the illustrated embodiment, the lockbox 24′ is similar to conventional mechanical lockboxes in that once opened by, e.g., entering a number combination via keypad 44, access is provided to a compartment 44 in which a standard key for the home 12 is stored. If the home 12 is of the type that has electronic locks, the lockbox 24′ may be fully electronic. Thus, the lockbox 24′ may have all of the features that conventional mechanical and electronic lockboxes have.

However, the lockbox 24′, which includes the wireless transmitter 28 and antenna 30, additionally has the capability of wirelessly transmitting the activation signal to the base unit 26 when the key is placed back into compartment 44 and secured (in the case of a mechanical lockbox) or when the door locks to the home 12 are automatically locked (in the case of a fully electronic lockbox). In the case of a mechanical lockbox, closing of the key compartment 44, closes the switch 38 between the battery 38 and the transmitter 28, thereby causing the transmitter to wirelessly transmit the activation signal to the base unit 26.

It should be noted that the use of a lockbox for the remote unit is advantageous in that the showing agent need not perform any activity other than that which is performed in the course of showing a home to a potential buyer. In this manner, the system 10 is transparent to the showing agent. Also, because the showing agent may forget to actuate the remote unit 24 or otherwise may not be aware that a resident communications system 18 is installed at the home 12, the use of a lockbox for the remote unit ensures that the home identifier is transmitted from the resident communications system 18 when the showing agent and potential buyer leave the home 12. Alternatively, rather than using a lockbox 24′, the remote unit 24 can take the form of a single mechanical actuating device, such as button-actuated transmitter, that can be pressed by the showing agent to transmit the activation signal, and thus, the home identifier from the home 12, when exiting the door. In this manner, the showing agent need only remember to push the button as he or she walks out of the house.

As another example, the remote unit 24 may automatically detect the ingress of the showing agent into the home 12 and/or egress of the showing agent from the home 12, and report this occurrence to the base unit 26. For example, the remote unit 24 can take the form of a radio frequency (RF) sensing device capable of sensing RF identification (RFID) tags. In this case, the RFID tag may be attached to a key ring that holds the key used by the showing agent to access the home 12, and the RF sensing device may be placed next to the entrance of the home 12 (typically within a 3 foot proximity). As the showing agent enters the home 12, the sensing device will automatically sense the RF tag on the key ring and record the date and time of entry. As the showing agent exits the home 12, the sensing device will again sense the RF tag on the key ring, and record the date and time of exit. The sensing device will then transmit the entry and exit information to the base unit 26 in the same manner previously described, with the base unit 26 then transmitting it, along with the home identifier, to the centralized showing system 20. The RFID sensed by the sensing device may be advantageously used as the home identifier transmitted from the base unit 26.

Each resident communications system 18 may optionally be configured for receiving subjective showing feedback information (e.g., the likes and dislikes of the showing agent and/or potential buyer, recommendations on pricing, decorations, maintenance, etc.) and/or objective showing feedback information (e.g., the time, date, and duration of the showing). The subjective and objective showing feedback information can either be entered into by the showing agent, or otherwise acquired by, the remote unit 24, in which case, it can be transmitted (either wirelessly or via wire) to the base unit 26, or the subject and objective showing feedback information can be directly entered into by the showing agent, or otherwise directly acquired by, the base unit 26. If a lockbox is used for the remote unit 24, the lockbox can be provided with a clock and a processor (not shown) that can automatically track the initiation and subsequent completion of a showing in order to automatically acquire the objective showing feedback information. Alternatively, the remote unit 24 or base unit 26 can have a multitude of buttons that can be operated by the showing agent to rank the home (single column of buttons) or different home categories (multiple columns of buttons). The home identifier can optionally be transmitted from the resident communications system 18 in response to operative of one of these buttons. In any event, the subject and objective information can either be stored in the resident communications system 18 for playback by the occupant 14, or can be transmitted to the centralized showing system 20 using the communications means described above.

Although the use of a remote unit 24 provides a convenient means for the showing agent to actuate transmission of the home identifier from home (whether or not the remote unit takes the form of lockbox), the resident communications system 18 may be entirely incorporated into a base unit, which preferably would be located near the ingress/egress of the home 12. Although it may not be as convenient for the showing agent, the resident communications system 18 may simply take the form of a standard telephone that may be used by the showing agent to make a phone call to the centralized showing system 20. For example, the showing agent may dial a toll-free phone number, and once answered, can convey the home identifier via voice or touchtone signals. Alternatively, if the centralized showing system 20 has caller identification capability, the home identifier will be transmitted to the centralized showing system 20 using caller identification signals, in which case, the showing agent need not affirmatively transmit the home identifier.

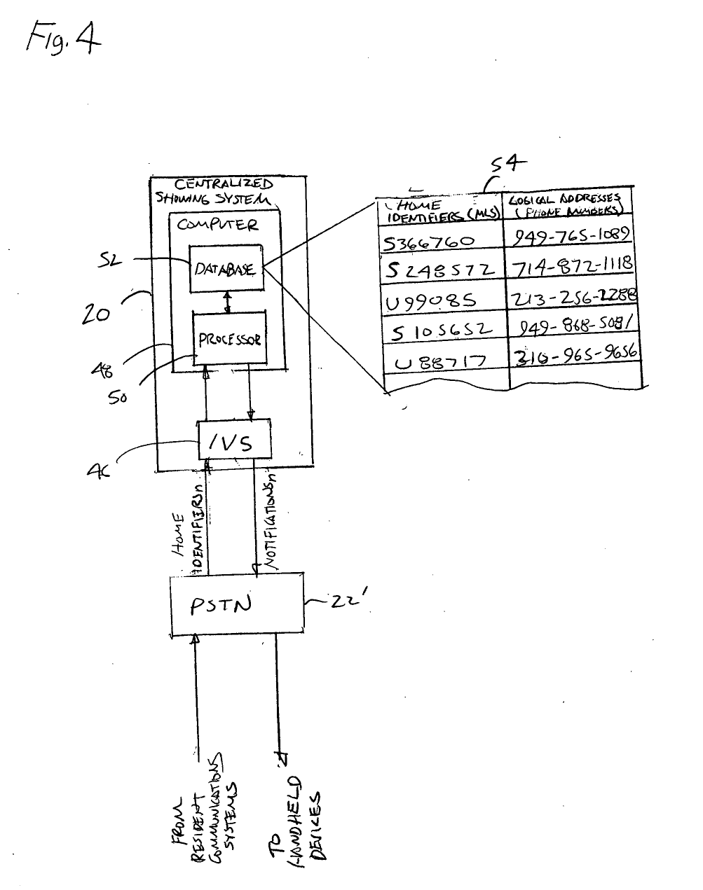

Referring still to FIG. 1, the centralized showing system 20 is configured for receiving the n number of home identifiers transmitted by the resident communications systems 18. The particular means used by the centralized showing system 20 for receiving the home identifiers will depend on the means used by the resident communications systems 18 for transmitting the home identifiers. In the embodiment illustrated in FIG. 4, the centralized showing system 20 comprises an interactive voice response (IVR) device 46 configured for receiving the voice or DTMF tones from the PSTN 22′ and extract the home identifiers therefrom. Alternatively, if the resident communications systems 18 transmit the unique identifiers over an IP network, the centralized showing system 20 can use a computer server (not shown) for receiving the home identifiers from the IP network (as the communications medium 22). Or, if the resident communications systems 18 wirelessly transmits the home identifiers directly to the centralized showing system 20 over the air, the centralized showing system 20 can include a wireless receiver and antenna (not shown) for receiving and extracting the home identifiers from the RF signals. Alternatively, the centralized showing system 20 may have caller identification capability, in which case, it can obtain the home identifiers in the form of telephone numbers obtained as a result of identifying the callers. In this case, the PSTN 22′ transmits the home identifiers in the form of caller identification signals to the centralized showing system 20 in response to phone connections made with the resident communications systems 18.

The centralized showing system 20 is configured for correlating the received home identifiers with the handheld communications devices 16. To this end, the centralized showing system 20 comprises a computer 48, which may conveniently be a conventional personal computer (PC). The computer 48 comprises a database 50, which may take the form of a hard drive or a floppy disk, and a processor 52, which may take the form of a central processing unit (CPU).

The database 50 contains a look-up table 54 that contains the home identifiers and corresponding logical addresses for the handheld communications devices 16. The processor 52 is configured for accessing the look-up table 54 and correlating the home identifiers as they are received from the respective resident communications systems 18 to the logical addresses of the corresponding handheld communications devices 16.

As illustrated, the home identifiers are stored as MSL numbers, and the logical addresses for the handheld communications devices 16 are stored as telephone numbers. The home identifiers and corresponding logical addresses can, e.g., be manually entered into the look-up table 54 by a human operator located at the centralized showing system 20, or can be entered into the look-up table 54 remotely by listing agents. In the later example, the computer 48 may act as server that allows the showing agents to remotely enter and transmit the home identifiers/logical addresses to the centralized showing system 20 via a web page displayed on the showing agent's computer, which will then be stored in the look-up table 54. Or the home identifiers and corresponding logical addresses can be entered into the resident communications systems 18, which may be configured for automatically transmitting this information to a human operator for manual input into the look-up table 54 or to the IVR device 46 for automatic input into the look-up table 54.

Alternatively, the home identifiers/logical addresses can be pre-stored on a computer disk (e.g., a compact disk (CD)), which can then be downloaded into the look-up table 54 of the database 52. For example, if the handheld communications devices 16 are dedicated, their logical addresses, along with corresponding serial numbers (as home identifiers) assigned to matched base units 26, can be stored on the computer disk by the manufacturer of the handheld communications devices 16. This feature avoids the need for individually inputting home identifiers/logical addresses into the look-up table 54, and more importantly, obviates the need for the listing agents to be involved with this input function, thereby reducing their workload.

The centralized showing system 20 is further configured for automatically contacting the occupants 14 via the respective handheld communications devices 16 in accordance with the correlated home identifiers, and automatically informing the occupants 14 that the showings of their respective homes have been completed. In the illustrated embodiment, an n number of notifications are transmitted to the respective n number of handheld communications devices 16. The IVR device 46 is configured, upon receipt of the logical addresses from the computer 48, to make phone calls to the corresponding handheld communications devices 16 via the communications medium 23, and in this case, the same PSTN used to receive home identifiers from the resident communications systems 18. That is, the IVR device 46 will transmit the logical addresses, and in particular, the telephone numbers of the handheld communications devices 16, to the PSTN 22′ using DTMF tones. The PSTN 22′, will then, in turn, connect the handheld communications devices 16 to the IVR device 46. The IVR device 46 will then transmit pre-recorded voice messages to the handheld communications devices 16 via the PSTN 22′.

Alternatively, if the handheld communications devices 16 are so enabled, the IVR device 46 may be configured for wirelessly transmitting text messages to the handheld communications devices 16 over a wireless telephone network (as the communications medium 23). Alternatively, if the handheld communications devices 16 are electronic mail devices, the centralized showing system 20 may have a server (which may be the same alternative server that receives electronic mail messages from the resident communications systems 18) configured for transmitting electronic mail messages to the handheld communications devices 16 over an IP network (as the communications medium 23).

If the handheld communications devices 16 are devices that have radio receivers, the centralized showing system 20 may include a radio transmitter and associated antenna (not shown) that wirelessly transmits the radio waves containing the prerecorded message to the handheld communications devices 16 over the air (as the communications medium 23), which will be tuned to the frequency at which the radio transmitter transmits. Alternatively, if the handheld communications devices 16 store prerecorded messages, the radio transmitter of the centralized showing system 20 would wirelessly transmit activation signals, which when received, will prompt the handheld communications devices 16 to playback the recordings to the respective occupants 14. In order to allow these types of handheld communications devices 16 to be specifically and individually addressed, the handheld communications devices 16 can be assigned different frequencies to avoid crossover between transmissions from the radio transmitter of the centralized showing system 20 and the many handheld communications devices 16 that may be receiving the transmissions in the same general geographical location.

Although the embodiments of the centralized showing system 20 have been described as automatically contacting and informing the occupants 14, thereby providing for a more efficient and less costly means of notification, the centralized showing system 20 can alternatively or optionally be configured, such that the occupants 14 can be manually contacted and informed by live operators. In this case, the live operators can have direct or remote access to the computer 48 to obtain the correlated logical addresses of the handheld communications devices 16. The operators can then use these logical addresses (phone numbers/email addresses/frequency, etc.) to manually call or send a text message to the handheld communications devices 16 using a standard telephone over the PSTN or wireless telephone network, or manually transmit an electronic mail message to the handheld communications devices 16 over an IP network, or otherwise manually activate a switch to wirelessly transmit an RF signal to the handheld communications devices 16 over the air.

In optional embodiments, the centralized showing system 20 automatically contacts and informs the occupants 14 that the showing is completed after a predetermined period of time has elapsed in order to ensure that the showing agent and potential buyer have left the home 12. For example, a five-minute delay can be built into the notification process.

The centralized showing system 20 may optionally be configured for playing back subjective showing feedback information and/or objective showing feedback information. For example, if the subjective/objective showing information is entered into and transmitted from the resident communications systems 18 over the communications medium 22, the IVR device 46 can be used to receive the subjective showing feedback information and/or objective showing feedback information from the resident communications system 18. Alternatively, the subjective/objective showing information can be transmitted from a remote computer, in which case, the centralized showing system 20 may comprise a computer server that generates a web page for entering such information. In either case, the database 50 may also be used to store the subjective/objective showing information for subsequent feedback to the listing agents either at the centralized showing system 20 or remotely via the IVR device 46 or other means of communications, such as text messaging, electronic mail, or providing a web site. Notably, the objective showing feedback information can advantageously take the form of a report that provides the amount of time that the occupant 14 saved based on the scheduled showing time and the actual time that the listing agent and potential buyer left the home 12.

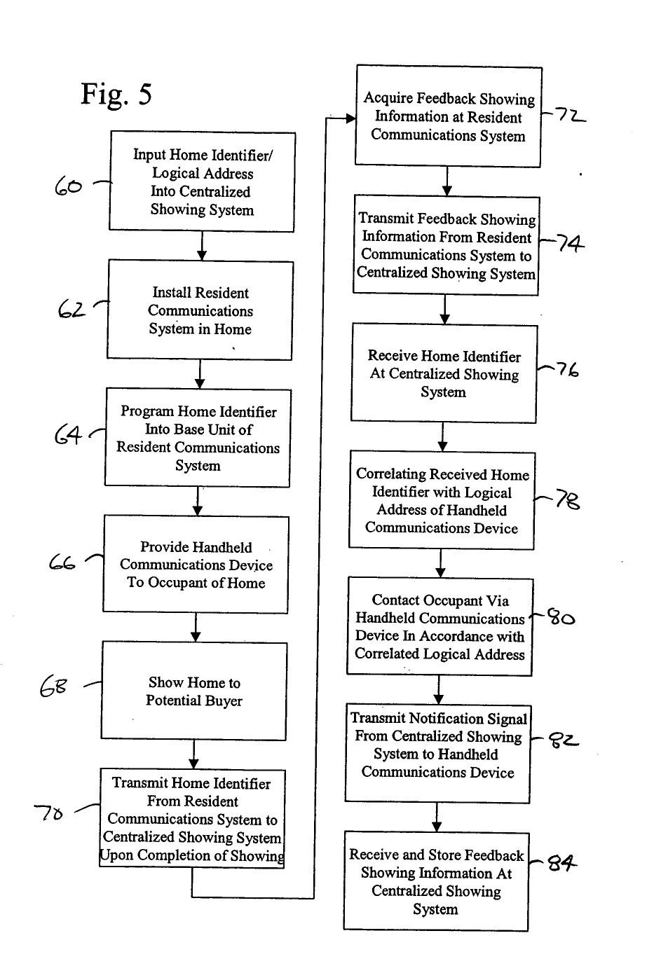

Having described the structure and arrangement of the home showing notification system 10, one preferred method of using the system to notify an occupant 14 of a home 12 that is to be shown to potential buyers as a function of a real estate transaction will now be described. Referring to FIG. 5, the home identifier (e.g., the residential address, PIN, MSL number, a serial number, phone number, etc.) and the corresponding logical address for the associated handheld communications device 16 (e.g., phone number, electronic mail address, frequency, etc.) are input into the centralized showing system 20, and in particular, in the look-up table 54 of the database 50 (step 60). As briefly discussed above, this can be accomplished in any one of a variety of manners. For example, the listing agent for the home 12 may call and inform a human operator at the centralized showing system 20 of the home identifier/logical address, who will then manually enter this information into the look-up table 54. Or, the listing agent may remotely enter the home identifier/logical address into the centralized showing system 20 via a web page controlled by a server at the centralized showing system 20, or may enter the home identifier/logical address into the resident communications system 18 installed at the home 12, which then automatically transmits this information to the centralized showing system 20, where it is entered into the look-up table 54 manually via a human operator or automatically via the IVR device 46. It should be noted that this step could be skipped if the home identifier/logical address of a matched base unit 26/handheld communications device 16 has been pre-stored within the look-up table 54 in the manner discussed above.

The listing agent then installs the resident communications system 18 at the home 12, which may simply involve plugging the base unit 26 into the phone jack, and if required, an AC power outlet, and locating the remote unit 24 near the ingress/egress of the home 12 (step 62). If the remote unit 24 takes the form of a lockbox, the listing agent will install the remote unit 24 in the same manner that the listing agent installs a conventional lock box at the home 12. In this manner, installation of the remote unit 24 is transparent to the listing agent. Notably, if the base unit 26 acts as a wireless telephone or RF transmitter, it need not be plugged into a phone jack, and if the base unit 26 is computer-based, it may take the form of an already existing personal computer (PC), in which case, no hardware installation of the base unit 26 is required. Of course, if the resident communications system 18 is embodied in a standard telephone, no setup is required, since a telephone will typically already be installed at the home.

The home identifier is then programmed into the base unit 26 (step 64). As briefly discussed above, the base unit 26 may be designed, such that it automatically transmits the home identifier, along with the logical address of the handheld communications device 16 (which would also be entered by the listing agent into the base unit 26), to the centralized showing system 120 for storage in the look-up table 54. Again, this step can be skipped if a home identifier/logical address of a matched base unit 26/handheld communications device 16 has been pre-stored within the look-up table 54 in the manner discussed above, or if resident communications system 18 takes the form of a standard telephone.

Next, the handheld communications device 16 is provided to the occupant 14 of the home 12 (step 66). Of course, if the handheld communications device 16 takes the form of a non-dedicated device, such as a cellular telephone, PDA, Blackberry® device, etc., the occupant 14 may already own a suitable handheld communications device 16, in which case, this step may be skipped.

Next, the showing agent shows the home 12 to a potential home-buyer (step 68). Presumably, the occupant 14 of the home 12 has left and is roaming about with the handheld communications device 16. Once the showing of the home 12 has been completed, the showing agent causes the resident communications system 18 to transmit the home identifier over the communications medium 22 (e.g., over an PSTN, wireless telephone network, IP network, or directly over-the-air) to the centralized showing system 20 (step 70). In the illustrated method, this is accomplished by actuating the remote unit 24 (e.g., by locking the key back in the remote unit 24 if a lockbox, or by mechanical actuation of a single switch, such as by pushing a button), which transmits an activation signal to the base unit 26, which in turn, responds by transmitting the home identifier. Of course, if the resident communications system 18 is entirely incorporated into a base unit, the showing agent will directly actuate the base unit to cause it to transmit the home identifier. If the resident communications system 18 takes the form of a standard telephone, the showing agent will pickup the telephone handset and call the centralized showing system 20, in which case, the home identifier may be transmitted via voice or touchtone signals, or not transmitted at all, if the centralized showing system 20 is enabled to automatically identify the telephone number of the caller.

The showing agent may optionally input subjective showing feedback information and/or objective showing feedback information into the resident communications system 18, either via the remote unit 24 or the base unit 26 (step 72). This showing feedback information is then transmitted from the base unit 26 over the same communications medium as the home identifier is transmitted (step 74). Alternatively, the showing feedback information is stored within the base unit 26 for subsequent playback by the occupant 14 or listing agent.

Next, the centralized showing system 20 receives the home identifier from the resident communications system 18 over the communications medium 22 (e.g., over an PSTN, wireless telephone network, IP network, or directly over-the-air), or otherwise receive the home identifier in the form of caller identification signals directly from the communications medium 22 in response to a phone call from the resident communications system 18 (step 76). Then, the centralized showing system 20 correlates the received home identifier with the handheld communications device 16 (step 78). This is accomplished by accessing the look-up table 54 to find the home identifier stored therein, and obtaining the corresponding logical address stored with the home identifier.

Then, the centralized showing system 20 contacts the occupant 14 via the handheld communications device (with or without a delay) in accordance with the correlated home identifier (i.e., the logical address) (step 80). The occupant 14 is contacted over the communications medium 23 (e.g., over the PSTN, cellular network, IP network, or directly over-the-air). Once the occupant 14 has been contacted, the centralized showing system 20 informs the occupant 14 that the showing of the home 12 has been completed by transmitting a notification signal to the handheld communications device 16 (step 82). For example, the occupant 14 may be informed via a pre-recorded voice message (either by transmitting the voice message itself or transmitting an activation signal that causes the voice message to playback in the handheld communications device 16), text message, electronic mail message, etc., which preferably is automatically transmitted to the occupant 14, but may be manually transmitted (e.g., using live voice, manually typing and sending a text or electronic mail message, or simply manually activating a button) if desired.

Lastly, the centralized showing system 20 receives the subjective/objective showing information from the resident communications system 18 over the communications medium 22 and stores it within the database 52 of the computer 48 for subsequent playback (step 84). Of course, if the subjective/objective showing information is not transmitted to the centralized showing system 20 from the resident communications system 18, either because this information is stored and played back from the base unit 26 or was never entered into the resident communications system 18, this information will not be stored at the centralized showing system 20.

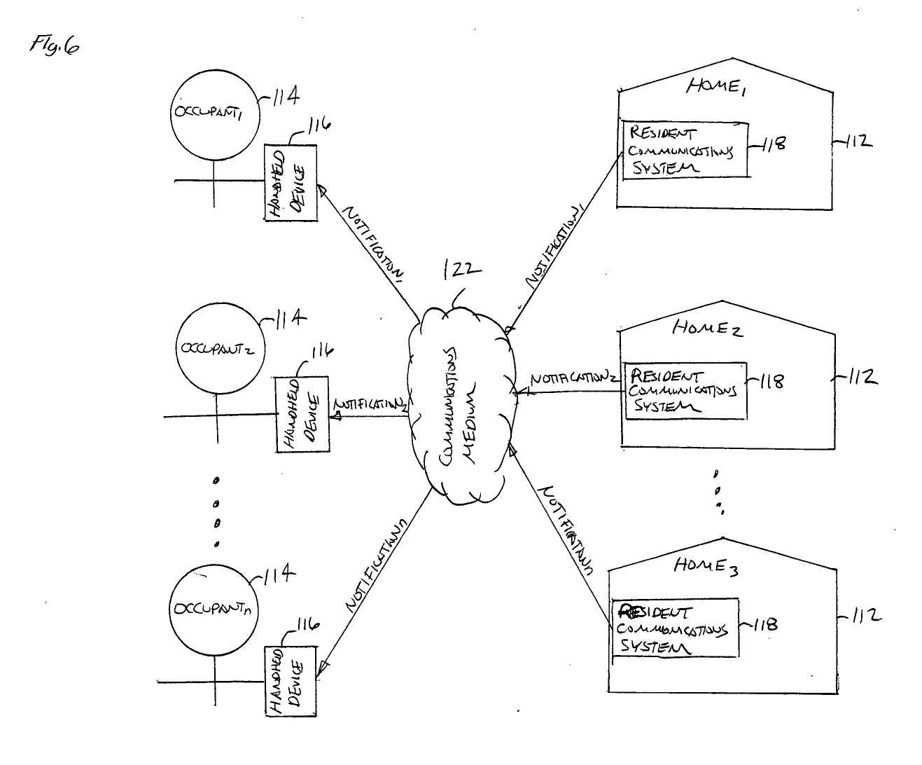

Referring to FIG. 6, an alternative embodiment of a home showing notification system 110 will now be described. The system 110 is similar to the previously described system 10, with the exception that it comprises resident communications systems 118 that are configured for communicating directly with the handheld communications devices 120, obviating the need for a centralized showing system. In effect, many of the functions previously performed by the centralized showing system 20 are distributed amongst the resident communications systems 118. In this case, the resident communications systems 118 are configured for automatically contacting the occupants 114 via the respective handheld communications devices 116 using the logical addresses of the handheld communications devices 116, and informing the occupants 114 that the showings of their respective homes have been completed.

To this end, the base unit of each resident communications system 118 will be programmed within the logical address of the corresponding handheld communications device 116 (e.g., the telephone number, electronic mail address, or frequency), which will be used to contact the respective handheld communications device 116 over the communications medium 122 in response to an activation signal received from the respective remote unit (if it exists) or in response to direct actuation from the showing agent if a remote unit does not exist.

The base unit of each resident communications system 118 may have the same hardware as the previously described base unit 126, but will be programmed to contact the handheld communications devices 116 rather than a centralizing showing system. For example, each base unit of the resident communications system 118 may comprise a conventional autodialer configured for making a phone call to the handheld communications device 114 over a PSTN or wireless telephone network. The autodialer will then transmit a pre-recorded voice message to the handheld communications device 116 via the PSTN or wireless telephone network.

Alternatively, if the handheld communications devices 116 are so enabled, the base unit of each resident communications system 118 may be configured for wirelessly transmitting a text message to the handheld communications device 116. Alternatively, if the handheld communications devices 16 are electronic mail devices, the base unit of each resident communications system 118 may have a computer configured for transmitting an electronic mail message to the handheld communications device 116 over an IP network. If the handheld communications devices 16 are devices that have radio receivers, the base unit of each handheld communications device 116 may include a radio transmitter and associated antenna (not shown) that wirelessly transmits the prerecorded message to the handheld communications device 116 over the air, or if the handheld communications devices 116 store prerecorded messages, the radio transmitter of the base unit would wirelessly transmit an activation signal, which when received, will prompt the handheld communications device 116 to playback the recording to the respective occupant 114.

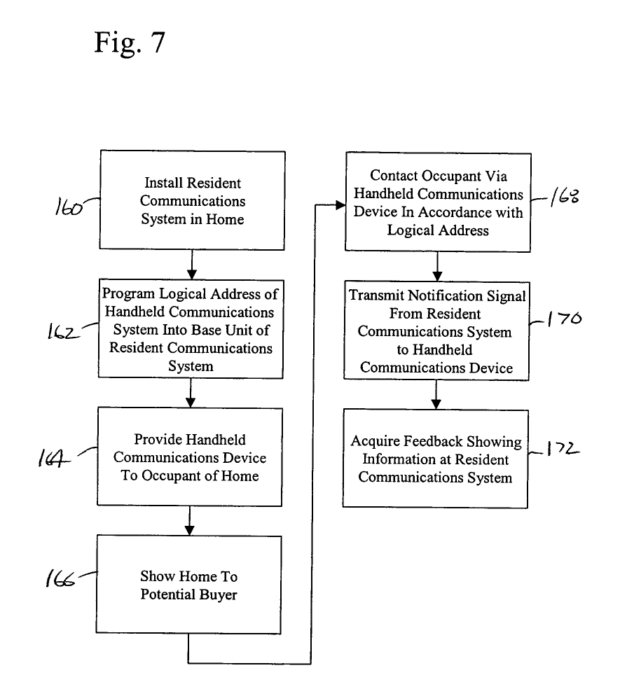

Having described the structure and arrangement of the home showing notification system 110, one preferred method of using the system to notify an occupant 114 of a home that is to be shown to potential buyers as a function of a real estate transaction will now be described. Referring to FIG. 7, the listing agent then installs the resident communications system 118 at the home 112 in the same manner as the resident communications system 18 is installed at step 102 of FIG. 5 (step 160). The logical address of the associated handheld communications device 116 (e.g., phone number, electronic mail address, frequency, etc.) is then stored in the base unit of the remote communications system 118 (step 162).

Next, the handheld communications device 16, if dedicated, is provided to the occupant 114 of the home 112 (step 164). Next, the showing agent shows the home 112 to a potential home-buyer (step 166). Once the showing is completed, the showing agent actuates the resident communications system 18 to contact the handheld communications device 116 over the communications medium 122 (e.g., over the PSTN, cellular network, IP network, or directly over-the-air) (step 168). For example, in the same manner described above with respect to step 70 of FIG. 5, the showing agent may actuate the remote unit of the resident communications system 118, or if there is no remote unit, the showing agent can directly actuate the base unit.

Once the occupant 114 has been contacted, the base unit of the resident communications system 118 informs the occupant 114 that the showing of the home 112 has been completed (step 170). For example, the occupant 114 may be informed via a pre-recorded voice message (either by transmitting the voice message itself or transmitting an activation signal that causes the voice message to playback in the handheld communications device 16), text message, electronic mail message, etc. The showing agent may optionally input subjective showing feedback information and/or objective showing feedback information into the resident communications system 118, either via the remote unit or the base unit (step 172).

Although particular embodiments of the present invention have been shown and described, it should be understood that the above discussion is not intended to limit the present invention to these embodiments. It will be obvious to those skilled in the art that various changes and modifications may be made without departing from the spirit and scope of the present invention. Thus, the present invention is intended to cover alternatives, modifications, and equivalents that may fall within the spirit and scope of the present invention as defined by the claims.

What is claimed:

1. A method for facilitating a real estate transaction, comprising:
showing a home from which an occupant is absent to a potential home buyer, the home having a resident communications system storing a home identifier correlatable to a handheld communications device carried by the occupant; and
transmitting the stored home identifier from the resident communications system upon completion of the home showing.

2. The method of claim 1, wherein the resident communications system comprises a base unit and a remote unit, the method further comprising transmitting an activation signal from the remote unit to the base unit, wherein the home identifier is transmitted from the base unit in response to the activation signal.

3. The method of claim 2, wherein the activation signal is wirelessly transmitted from the remote unit to the base unit.

4. The method of claim 2, wherein the remote unit is located at an ingress/egress of the home.

5. The method of claim 1, further comprising automatically sensing an egress event, wherein the home identifier is transmitted in response to the sensed egress event.

6. The method of claim 5, wherein the egress event is sensed by sensing a radio frequency identification (RFID) tag.

7. The method of claim 1, wherein the resident communications system comprises a lockbox, and the home identifier is transmitted in response to operation of the lockbox.

8. The method of claim 7, wherein the home identifier is transmitted in response to locking a key within the lockbox.

9. The method of claim 1, wherein the home identifier is transmitted in response to the mechanical actuation of a single switch.

10. The method of claim 1, wherein the home identifier is transmitted from the resident communications system over a public switched telephone network (PSTN).

11. The method of claim 1, wherein the home identifier is transmitted from the resident communications system over an Internet protocol (IP) network.

12. The method of claim 1, wherein the home identifier is wirelessly transmitted from the resident communications system.

13. The method of claim 1, further comprising acquiring showing feedback information at the resident communications system.

14. The method of claim 1, wherein the home identifier comprises at least one of a residential address, a property identification number (PIN), a multiple listing service (MLS) number, a serial number, and a phone number.

15. The method of claim 1, wherein the home identifier is transmitted to a centralized showing system.

16. A method for facilitating a real estate transaction, comprising:
showing a home from which an occupant is absent to a potential home buyer, the home having a lockbox; and
operating the lockbox to transmit a home identifier correlatable to a handheld communications device upon completion of the home showing.

17. The method of claim 16, further comprising transmitting an activation signal from the lockbox to a resident base unit upon operation of the lockbox, wherein the home identifier is transmitted from the base unit in response to the activation signal.

18. The method of claim 17, wherein the activation signal is wirelessly transmitted from the lockbox to the base unit.

19. The method of claim 16, wherein the home identifier is transmitted in response to locking a key within the lockbox.

20. The method of claim 16, further comprising inputting subjective showing feedback information into the lockbox.

21. The method of claim 16, further comprising acquiring objective showing feedback information via the lockbox.

22. The method of claim 16, wherein the home identifier comprises at least one of a residential address, a property identification number (PIN), a multiple listing service listing (MLS) number, a serial number, and a phone number.

23. The method of claim 16, wherein the home identifier is transmitted to a centralized showing system.

24. A method for facilitating a real estate transaction, comprising:
showing a home from which an occupant is absent to a potential home buyer, the home having a resident communications system storing a logical address of a handheld communications device carried by the occupant; and
transmitting a notification signal from the resident communications system to the handheld communications device in accordance with the stored logical address upon completion of the home showing.

25. The method of claim 24, wherein the resident communications system comprises a base unit and a remote unit, the method further comprising transmitting an activation signal from the remote unit to the base unit, wherein the home identifier is transmitted from the base unit in response to the activation signal.

26. The method of claim 25, wherein the activation signal is wirelessly transmitted from the remote unit to the base unit.

27. The method of claim 25, wherein the remote unit is located at an ingress/egress of the home.

28. The method of claim 25, further comprising automatically sensing an egress event, wherein the home identifier is transmitted in response to the sensed egress event.

29. The method of claim 28, wherein the egress event is sensed by sensing a radio frequency identification (RFID) tag.

30. The method of claim 25, wherein the resident communications system comprises a lockbox, and the home identifier is transmitted in response to operation of the lockbox.

31. The method of claim 30, wherein the home identifier is transmitted in response to locking a key within the lockbox.

32. The method of claim 25, wherein the home identifier is transmitted in response to the mechanical actuation of a single switch.

33. The method of claim 25, wherein the notification signal comprises a pre-recorded voice message.

34. The method of claim 25, wherein the handheld communications device stores a pre-recorded voice message indicating that the showing has been completed, and the notification signal is configured for prompting the handheld communications device to playback the voice message.

35. The method of claim 25, wherein the notification signal comprises one or more of a text message and electronic mail message.

36. A method for facilitating a real estate transaction, comprising:
showing a home from which an occupant is absent to a potential home buyer; and
operating a lockbox at the home to transmit a notification signal to a handheld communications device carried by the occupant upon completion of the home showing.

37. The method of claim 36, further comprising transmitting an activation signal from the lockbox to a resident base unit upon operation of the lockbox, wherein the notification signal is transmitted from the base unit in response to the activation signal.

38. The method of claim 37, wherein the activation signal is wirelessly transmitted from the lockbox to the base unit.

39. The method of claim 36, wherein the home identifier is transmitted in response to locking a key within the lockbox.

40. The method of claim 36, further comprising acquiring showing feedback information at the lockbox.

41. The method of claim 36, wherein the notification signal contains a recording indicating that the showing has been completed.

42. The method of claim 36, wherein the handheld communications device stores a recording indicating that the showing has been completed, and notification signal is configured for prompting the handheld communications device to playback the recording.

43. The method of claim 35, wherein the notification signal comprises one or more of a text message and an electronic mail message.

44. A centralized method of facilitating the sales of homes from which occupants are absent, the occupants carrying handheld communications devices, comprising:
receiving home identifiers;
correlating the home identifiers with the handheld communications devices;
contacting the occupants via the respective handheld communications device in accordance with the correlated home identifiers; and
informing the occupants that the showings of the respective homes have been completed.

45. The method of claim 44, wherein the home identifiers are received over a public switched telephone network (PSTN).

46. The method of claim 44, wherein the home identifiers are received over an Internet protocol (IP) network.

47. The method of claim 44, wherein the home identifiers are wirelessly received.

48. The method of claim 44, further comprising:
receiving showing feedback information; and
storing the received showing feedback information.

49. The method of claim 44, wherein each home identifier comprises at least one of a residential address, a property identification number (PIN), a multiple service listing (MSL) number, a serial number, and a phone number.

50. The method of claim 44, further comprising contacting the occupants after a predetermined period of time has expired after receipt of the respective home identifiers.

51. The method of claim 44, wherein the occupants are manually contacted.

52. The method of claim 44, wherein the occupants are automatically contacted.

53. The method of claim 44, wherein the occupants are wirelessly contacted.

54. The method of claim 44, wherein the occupants are informed via live voices.

55. The method of claim 44, wherein the occupants are informed via electronic voice messages.

56. The method of claim 55, wherein the voice messages are transmitted to the respective handheld communications devices.

57. The method of claim 55, wherein the handheld communications devices store the voice messages, and activation signals are transmitted to prompt the respective handheld communications devices to playback the voice messages.

58. The method of claim 44, wherein the occupants are informed via one or more of text messages and electronic mail messages.

59. The method of claim 44, further comprising installing resident communications system at the homes, wherein the resident communications systems are configured for transmitting the home identifiers upon completion of the respective home showings.

60. The method of claim 44, further comprising supplying the occupants with the respective handheld communications devices.

61. A centralized showing system for facilitating the sale of homes from which occupants are absent, the occupants carrying handheld communications devices, the system comprising:
means for receiving home identifiers;
a processor configured for correlating the received home identifiers with the handheld communications devices;
means for automatically contacting the occupants via the respective handheld communications device in accordance with the correlated home identifiers; and
means for informing the occupants that the showings of the respective homes have been completed.

62. The system of claim 61, wherein receiving means comprises a telephonic device.

63. The system of claim 61, wherein the receiving means comprises an Internet protocol (IP) server.

64. The system of claim 61, wherein the receiving means comprises a radio frequency (RF) receiver.

65. The system of claim 61, wherein the receiving means is configured for receiving showing feedback information, the system comprises memory for storing the showing feedback information.

66. The system of claim 61, wherein each home identifier comprises at least one of a residential address, a property identification number (PIN), a multiple service listing (MSL) number, a serial number, and a phone number.

67. The system of claim 61, wherein the contacting means is configured for delaying contact with at least one of the occupants after receipt of a respective at least one home identifier.

68. The system of claim 61, wherein the contacting means comprises a telephonic device.

69. The system of claim 61, wherein the contacting means comprises an autodialer.

70. The system of claim 61, wherein the contacting means comprises an internet protocol (IP) server

71. The system of claim 61, wherein the contacting means comprises a radio frequency (RF) transmitter.

72. The system of claim 61, further comprising a look-up table for storing the home identifiers and corresponding logical addresses for the handheld communications devices, wherein the processor accesses the look-up table to perform the correlation function.

73. A system for facilitating the sale of homes from which occupants are absent, the occupants carrying handheld communications devices, comprising:
a plurality of resident communications systems located at the respective homes, the resident communications systems configured for transmitting home identifiers from the respective homes; and
a centralized showing system configured for receiving the transmitted home identifiers, correlating the received home identifiers with the handheld communications devices, contacting the occupants via the respective handheld communications devices in accordance with the correlated home identifiers, and informing the occupants that the showings of the respective homes have been completed.

74. The system of claim 73, wherein each resident communications system comprises a base unit and a remote unit, the remote unit is configured for transmitting an activation signal to the base unit, and the base unit is configured for transmitting the respective home identifier in response to the activation signal.

75. The system of claim 73, wherein each resident communications system comprises a sensing device configured for automatically sensing an egress event for causing transmission of the respective home identifier in response to the sensed egress event.

76. The system of claim 75, wherein the egress event is sensed by sensing a radio frequency identification (RFID) tag.

77. The system of claim 73, wherein each resident communications system comprises a lockbox configured for causing transmission of the respective home identifier in response to operation of the lockbox.

78. The system of claim 73, wherein each resident communications system is configured for transmitting the respective home identifier in response to the mechanical actuation of a single switch.

79. The system of claim 73, wherein each resident communications system is configured for transmitting showing feedback information, and the centralized showing system is configured for receiving the transmitted showing feedback information from the resident communications systems, and storing the received showing feedback information.

80. The system of claim 73, wherein the centralized showing system is configured for automatically contacting and informing the occupants.

81. A resident communications system for facilitating the sale of a home from which an occupant is absent, comprising:
a remote unit configured for being actuated to transmit an activation signal; and
a base unit configured for receiving the activation signal, and in response thereto, transmitting a message to a handheld communication device carried by the occupant, the message expressly indicating that a showing of the home has been completed.

82. The system of claim 81, wherein the remote unit is configured for wirelessly transmitting the activation signal, and the base unit is configured for wirelessly receiving the activation signal.

83. The system of claim 81, wherein the remote unit configured for being located at an ingress/egress of the home.

84. The system of claim 81, wherein the remote unit comprises a sensing device configured for automatically sensing an egress event, the remote unit being configured for automatically transmitting the activation signal in response to the sensed egress event.

85. The system of claim 84, wherein the egress event is sensed by sensing a radio frequency identification (RFID) tag.

86. The system of claim 81, wherein the remote unit comprises a lockbox configured for transmitting the activation signal in response to operation of the lock box.

87. The system of claim 86, wherein the lockbox is configured for transmitting the activation signal in response to locking a key within the lockbox.

88. The system of claim 81, wherein the remote unit comprises a single switch configured for being mechanically actuated to transmit the activation signal.

89. The system of claim 81, wherein the message is a pre-recorded voice message.

90. The system of claim 81, wherein the message is one of a text message and an electronic mail message.

91. A system for facilitating the sale of a home from which an occupant is absent, comprising:
a handheld communications device having a logical address and being configured for providing the occupant with a message expressly indicating that a showing of the home has been completed in response to a notification signal; and
a resident communications system located at the home, the resident communications system storing the logical address of the handheld communications system and being configured for transmitting the notification signal to the handheld communications device in accordance with the stored logical address upon completion of the home showing.

92. The system of claim 91, wherein the resident communications system comprises:
a remote unit configured for being actuated to transmit an activation signal; and
a base unit configured for receiving the activation signal, and in response thereto, transmitting the notification signal to the handheld communication device.

93. The system of claim 92, wherein the remote unit is configured for wirelessly transmitting the activation signal, and the base unit is configured for wirelessly receiving the activation signal.

94. The system of claim 92, wherein the remote unit is configured for being located at an ingress/egress of the home.

95. The system of claim 92, wherein the remote unit comprises a sensing device configured for automatically sensing an egress event, the remote unit configured for transmitting the activation signal in response to the sensed egress event.

96. The system of claim 95, wherein the egress event is sensed by sensing a radio frequency identification (RFID) tag.

97. The system of claim 92, wherein the remote unit comprises a lockbox configured for transmitting the activation signal in response to operation of the lock box.

98. The system of claim 97, wherein the lockbox is configured for transmitting the activation signal in response to locking a key within the lockbox.

99. The system of claim 92, wherein the remote unit comprises a single switch configured for being mechanically actuated to transmit the activation signal.

100. The system of claim 91, wherein the notification signal comprises a pre-recorded voice message.

101. The system of claim 91, wherein the handheld communications device stores a pre-recorded voice message indicating that the showing has been completed, and the notification signal is configured for prompting the handheld communications device to playback the voice message.

102. The system of claim 91, wherein the notification signal comprises one of a text message and an electronic mail message.

103. A method for facilitating the performance of a task, comprising:
performing the task at a home from which an occupant is absent, the home having a resident communications system storing a home identifier correlatable to a handheld communications device carried by the occupant; and
transmitting the stored home identifier from the resident communications system upon completion of the task.

104. The method of claim 103, wherein the resident communications system comprises a base unit and a remote unit, the method further comprising transmitting an activation signal from the remote unit to the base unit, wherein the home identifier is transmitted from the base unit in response to the activation signal.

105. The method of claim 104, wherein the activation signal is wirelessly transmitted from the remote unit to the base unit.

106. The method of claim 104, wherein the remote unit is located at an ingress/egress of the home.

107. The method of claim 103, wherein the home identifier is transmitted in response to the mechanical actuation of a single switch.

108. The method of claim 103, wherein the home identifier is transmitted from the resident communications system over a public switched telephone network (PSTN).

109. The method of claim 103, wherein the home identifier is transmitted from the resident communications system over an internet protocol (IP) network.

110. The method of claim 103, wherein the home identifier is wirelessly transmitted from the resident communications system.

111. The method of claim 103, further comprising acquiring showing feedback information at the resident communications system.

112. The method of claim 103, wherein the home identifier comprises at least one of a residential address, a property identification number (PIN), a serial number, and a phone number.

113. The method of claim 103, wherein the home identifier is transmitted to a centralized showing system.

114. A method for facilitating the performance of a task, comprising:
performing a task at a home from which an occupant is absent, the home having a resident communications system storing a logical address of a handheld communications device carried by the occupant; and
transmitting a notification signal from the resident communications system to the handheld communications device in accordance with the stored logical address upon completion of the task.

115. The method of claim 114, wherein the resident communications system comprises a base unit and a remote unit, the method further comprising transmitting an activation signal from the remote unit to the base unit, wherein the home identifier is transmitted from the base unit in response to the activation signal.

116. The method of claim 114, wherein the activation signal is wirelessly transmitted from the remote unit to the base unit.

117. The method of claim 114, wherein the remote unit is located at an ingress/egress of the home.

118. The method of claim 114, wherein the home identifier is transmitted in response to the mechanical actuation of a single switch.

119. The method of claim 114, wherein the notification signal comprises a pre-recorded voice message.

120. The method of claim 114, wherein the handheld communications device stores a pre-recorded voice message indicating that the showing has been completed, and the notification signal is configured for prompting the handheld communications device to playback the voice message.

121. The method of claim 114, wherein the notification signal comprises one or more of a text message and electronic mail message.

122. A centralized method of facilitating the performance of tasks at homes from which occupants are absent, the occupants carrying handheld communications devices, comprising:
receiving home identifiers;
correlating the home identifiers with the handheld communications devices;
contacting the occupants via the respective handheld communications device in accordance with the correlated home identifiers; and
informing the occupants that the performances of tasks at the respective homes have been completed.

123. The method of claim 122, wherein the home identifiers are received over a public switched telephone network (PSTN).

124. The method of claim 122, wherein the home identifiers are received over an internet protocol (IP) network.

125. The method of claim 122, wherein the home identifiers are wirelessly received.

126. The method of claim 122, wherein each home identifier comprises at least one of a residential address, a property identification number (PIN), a serial number, and a phone number.

127. The method of claim 122, further comprising contacting the occupants after a predetermined period of time has expired after receipt of the respective home identifiers.

128. The method of claim 122, wherein the occupants are manually contacted.

129. The method of claim 122, wherein the occupants are automatically contacted.

130. The method of claim 122, wherein the occupants are wirelessly contacted.

131. The method of claim 122, wherein the occupants are informed via live voices.

132. The method of claim 122, wherein the occupants are informed via electronic voice messages.

133. The method of claim 132, wherein the voice messages are transmitted to the respective handheld communications devices.

134. The method of claim 132, wherein the handheld communications devices store the voice messages, and activation signals are transmitted to prompt the respective handheld communications devices to playback the voice messages.

135. The method of claim 122, wherein the occupants are informed via one or more of text messages and electronic mail messages.

136. The method of claim 122, further comprising installing resident communications system at the homes, wherein the resident communications systems are configured for transmitting the home identifiers upon completion of the respective home showings.

137. The method of claim 122, further comprising supplying the occupants with the respective handheld communications devices.

138. A centralized showing system for facilitating the performances of tasks at homes from which occupants are absent, the occupants carrying handheld communications devices, the system comprising:
means for receiving home identifiers;
a processor configured for correlating the received home identifiers with the handheld communications devices;
means for automatically contacting the occupants via the respective handheld communications device in accordance with the correlated home identifiers; and
means for informing the occupants that the tasks performed at the respective homes have been completed.

139. The system of claim 138, wherein receiving means comprises a telephonic device.

140. The system of claim 138, wherein the receiving means comprises an internet protocol (IP) server.

141. The system of claim 138, wherein the receiving means comprises a radio frequency (RF) receiver.

142. The system of claim 138, wherein the receiving means is configured for receiving showing feedback information, the system comprises memory for storing the showing feedback information.

143. The system of claim 138, wherein each home identifier comprises at least one of a residential address, a property identification number (PIN), a serial number, and a phone number.

144. The system of claim 138, wherein the contacting means is configured for delaying contact with at least one of the occupants after receipt of a respective at least one home identifier.

145. The system of claim 138, wherein the contacting means comprises a telephonic device.

146. The system of claim 138, wherein the contacting means comprises an autodialer.

147. The system of claim 138, wherein the contacting means comprises an internet protocol (IP) server

148. The system of claim 138, wherein the contacting means comprises a radio frequency (RF) transmitter.

149. The system of claim 138, further comprising a look-up table for storing the home identifiers and corresponding logical addresses for the handheld communications devices, wherein the processor accesses the look-up table to perform the correlation function.

150. A system for facilitating the performance of tasks at homes from which occupants are absent, the occupants carrying handheld communications devices, comprising:
a plurality of resident communications systems located at the respective homes, the resident communications systems configured for transmitting home identifiers from the respective homes; and
a centralized showing system configured for receiving the transmitted home identifiers, correlating the received home identifiers with the handheld communications devices, contacting the occupants via the respective handheld communications devices in accordance with the correlated home identifiers, and informing the occupants that the tasks performed at the respective homes have been completed.

151. The system of claim 150, wherein each resident communications system comprises a base unit and a remote unit, the remote unit is configured for transmitting an activation signal to the base unit, and the base unit is configured for transmitting the respective home identifier in response to the activation signal.

152. The system of claim 150, wherein each resident communications system is configured for transmitting the respective home identifier in response to the mechanical actuation of a single switch.

153. The system of claim 150, wherein each resident communications system is configured for transmitting showing feedback information, and the centralized showing system is configured for receiving the transmitted showing feedback information from the resident communications systems, and storing the received showing feedback information.

154. The system of claim 150, wherein the centralized showing system is configured for automatically contacting and informing the occupants.

155. A resident communications system for facilitating the performance of a task at a home from which an occupant is absent, comprising:
a remote unit configured for being actuated to transmit an activation signal; and
a base unit configured for receiving the activation signal, and in response thereto, transmitting a message to a handheld communication device carried by the occupant, the message expressly indicating that the task has been completed.

156. The system of claim 155, wherein the remote unit is configured for wirelessly transmitting the activation signal, and the base unit is configured for wirelessly receiving the activation signal.

157. The system of claim 155, wherein the remote unit configured for being located at an ingress/egress of the home.

158. The system of claim 155, wherein the remote unit comprises a single switch configured for being mechanically actuated to transmit the activation signal.

159. The system of claim 155, wherein the message is a pre-recorded voice message.

160. The system of claim 155, wherein the message is one of a text message and an electronic mail message.

161. A system for facilitating the performance of a task at a home from which an occupant is absent, comprising:
a handheld communications device having a logical address and being configured for providing the occupant with a message expressly indicating that the task has been completed in response to a notification signal; and
a resident communications system located at the home, the resident communications system storing the logical address of the handheld communications system and being configured for transmitting the notification signal to the handheld communications device in accordance with the stored logical address upon completion of the task.

162. The system of claim 161, wherein the resident communications system comprises:
a remote unit configured for being actuated to transmit an activation signal; and
a base unit configured for receiving the activation signal, and in response thereto, transmitting the notification signal to the handheld communication device.

163. The system of claim 162, wherein the remote unit is configured for wirelessly transmitting the activation signal, and the base unit is configured for wirelessly receiving the activation signal.

164. The system of claim 162, wherein the remote unit is configured for being located at an ingress/egress of the home.

165. The system of claim 162, wherein the remote unit comprises a single switch configured for being mechanically actuated to transmit the activation signal.

166. The system of claim 161, wherein the notification signal comprises a pre-recorded voice message.

167. The system of claim 161, wherein the handheld communications device stores a pre-recorded voice message indicating that the showing has been completed, and the notification signal is configured for prompting the handheld communications device to playback the voice message.

168. The system of claim 161, wherein the notification signal comprises one of a text message and an electronic mail message.
